(19) United States
(12) Patent Application Publication
(10) Pub. No.: US 2011/0087141 A1
(43) Pub. Date: Apr. 14, 2011

(54) Powered Massage Device

(75) Inventors: Roger Wagy, Lee's Summit, MO (US); Erica Knight, Atlanta, GA (US); Jonathan Schweiger, Atlanta, GA (US); Joseph Pruitt, Athens, GA (US)

(73) Assignee: Roger Wagy, Lee's Summit, MO (US)

(21) Appl. No.: 12/903,014

(22) Filed: Oct. 12, 2010

Related U.S. Application Data
(60) Provisional application No. 61/281,200, filed on Nov. 13, 2009.
(60) Provisional application No. 61/278,804, filed on Oct. 13, 2009.

(51) Int. Cl. A61H 7/00

(52) U.S. Cl. 601/137

(57) ABSTRACT

A powered massaging assembly includes a handle and a massage head each having an enclosure that presents a chamber. The massage head includes a drive shaft that extends into and out of the chamber. The massage head also includes a driven massage element drivingly attached to the drive shaft and mounted outside the chamber to manipulate tissue. The enclosures include connectors rotatably attached to each other to provide a swivel joint that rotatably interconnects the handle and head.

### RELATED APPLICATIONS

This application claims the benefit of U.S. Provisional Application Ser. No. 61/278,804, filed Oct. 13, 2009, entitled POWERED SKIN STIMULATION DEVICE, and U.S. Provisional Application Ser. No. 61/281,200, filed Nov. 13, 2009, entitled POWERED SKIN STIMULATION DEVICE, both of which are hereby incorporated in their entirety by reference herein.

### BACKGROUND

1. Field

The present invention relates generally to devices used to provide a massage. More specifically, embodiments of the present invention concern a powered massaging device.

2. Discussion of Prior Art

Various massage techniques are practiced to manipulate tissues and to thereby provide relaxation or other therapeutic benefits. These techniques involve the use of a hand or a structure that rubs, kneads, or otherwise contacts tissue. Conventional massage structures include simple hand-held structures with no moving parts. Prior art instruments also include massage elements that are powered so as to vibrate, move, or radiate heat.

Prior art massage instruments suffer from various deficiencies. For instance, hand-held massaging instruments are difficult to manipulate and control when used for self-massaging or for massaging of another person, such as when used to massage hard-to-reach areas. Powered massaging instruments are also heavy and bulky and are therefore inconvenient to carry for personal use.

### SUMMARY

The following brief summary is provided to indicate the nature of the subject matter disclosed herein. While certain aspects of the present invention are described below, the summary is not intended to limit the scope of the present invention.

Embodiments of the present invention provide a powered massaging device that does not suffer from the problems and limitations of the prior art massage instruments set forth above.

A first aspect of the present invention concerns a powered massaging assembly operable to manipulate tissue. The powered massaging assembly broadly includes a control handle and a massage head. The control handle includes a handle enclosure. The massage head includes a head enclosure that presents a chamber, a shiftable drive shaft that extends into and out of the chamber, and a driven massage element drivingly attached to the drive shaft, with the driven massage element being mounted outside the chamber to engage and thereby manipulate tissue. The enclosures each include a respective connector, with the connectors being rotatably attached to one another to cooperatively provide a swivel joint that interconnects the enclosures. The connectors cooperatively present an opening through the swivel joint so that the swivel joint permits power transfer from a location within the handle enclosure to the chamber by passing through the opening and thereby powering the drive shaft.

A second aspect of the present invention concerns a method of controlling a massaging device with a rotating massage element. The method broadly includes the steps of providing a shifting signal by sensing shifting of the device handle relative to the device massage element in a massage direction, with sensing being performed by a movement sensor of the massaging device; and changing the rotational direction of the massage element in response to the shifting signal with a controller that receives the shifting signal and correspondingly controls power to the device massage element

Other aspects and advantages of the present invention will be apparent from the following detailed description of the preferred embodiments and the accompanying drawing figures.

### BRIEF DESCRIPTION OF THE DRAWING FIGURES

Preferred embodiments of the invention are described in detail below with reference to the attached drawing figures, wherein:

FIG. 1 is a fragmentary perspective of a powered massaging device constructed in accordance with a preferred embodiment of the present invention, showing the device in use for self-massaging of a user's back, with the powered massaging device including a handle and a head with several types of massaging brushes, and showing a pair of regular rotation massaging brushes installed as part of the head;

FIG. 2 is an upper perspective of the powered massaging device similar to FIG. 1, showing upper surfaces of the handle and head, with the handle including controls positioned along the upper surface of the handle;

FIG. 3 is a lower fragmentary perspective of the powered massaging device shown in FIGS. 1 and 2, showing lower surfaces of the handle and head, with a control positioned along a lower surface of the handle and massaging brushes installed in the head;

FIG. 4 is a fragmentary cross section of the powered massaging device shown in FIGS. 1-3, with the handle including a handle enclosure and the head including a head enclosure, showing the enclosures being connected at a swivel joint, also showing a controller and batteries mounted within the handle enclosure, and further showing a motor and transmission of the head;

FIG. 5 is an enlarged fragmentary cross section of the powered massaging device shown in FIGS. 1-4, showing a distal part of the handle and the head attached to the handle at the swivel joint;

FIG. 6 is a fragmentary cross section of the powered massaging device shown in FIGS. 1-5, showing the brushes mounted on a drive shaft of the transmission;

FIG. 7 is a fragmentary exploded view of the powered massaging device shown in FIGS. 1-6;

FIG. 8 is a fragmentary top view of the powered massaging device shown in FIGS. 1-7, showing sleeves of the enclosures that cooperatively interconnect the head and handle, with the sleeves presenting shoulders to restrict relative pivotal movement between the sleeves to thereby restrict swiveling movement of the head relative to the handle, and showing the head pivoted into a forward-facing position with the shoulders out of engagement with one another;

FIG. 9 is a fragmentary top view of the powered massaging device similar to FIG. 8, but with the head being pivoted from the forward-facing position in a counterclockwise direction so that shoulders of the sleeves engage one another to restrict further counterclockwise rotation of the head relative to the handle, and further showing another head position in hidden lines where the head is pivoted from the forward-facing position in a clockwise direction so that the shoulders engage one another to restrict further clockwise head rotation relative to the handle;

FIG. 10 is a perspective view of a counter-rotation massaging brush of the powered massaging device, showing a frame, input shaft, cover, and bristle groups of the counter-rotation massaging brush;

FIG. 10a is a perspective view of the counter-rotation massaging brush similar to FIG. 10, but showing the brush cross-sectioned to show a transmission that drivingly interconnects the input shaft and cover;

FIG. 11 is a fragmentary cross section of the powered massaging device similar to FIG. 6, but showing one regular rotation massaging brush and one counter-rotation massaging brush mounted on the drive shaft of the transmission;

FIG. 12 is a fragmentary cross section of the powered massaging device shown in FIG. 11, showing the rotational direction of the drive shaft and the corresponding rotational direction of the regular rotation and counter-rotation massaging brushes;

FIG. 13 is a fragmentary perspective of the powered massaging device shown in FIGS. 1-3, but showing the regular rotation massaging brushes replaced with a pair of vibrating rollers attached to the drive shaft;

FIG. 14 is a fragmentary side elevation of the powered massaging device shown in FIG. 13, with one of the vibrating rollers cross sectioned to show a frame, rotatable cover, input shaft, transmission, retaining ring, and vibration mass of the vibrating roller;

FIG. 15 is a fragmentary cross section of the powered massaging device similar to FIG. 11, but showing the vibrating rollers attached to the drive shaft;

FIG. 16 is a fragmentary cross section of the powered massaging device shown in FIGS. 13-15, showing one of the vibrating rollers exploded from the head;

FIG. 17 is a fragmentary side elevation of the powered massaging device shown in FIGS. 1-3, but showing the regular rotation massaging brushes replaced with a pair of spring-loaded massaging rollers attached to the drive shaft;

FIG. 17a is a fragmentary front elevation of the spring-loaded massaging roller shown in FIG. 17, and

FIG. 18 is a schematic view of the power supply, motor, and controller.

The drawing figures do not limit the present invention to the specific embodiments disclosed and described herein. The drawings are not necessarily to scale, emphasis instead being placed upon clearly illustrating the principles of the preferred embodiments.

### DETAILED DESCRIPTION OF THE PREFERRED EMBODIMENTS

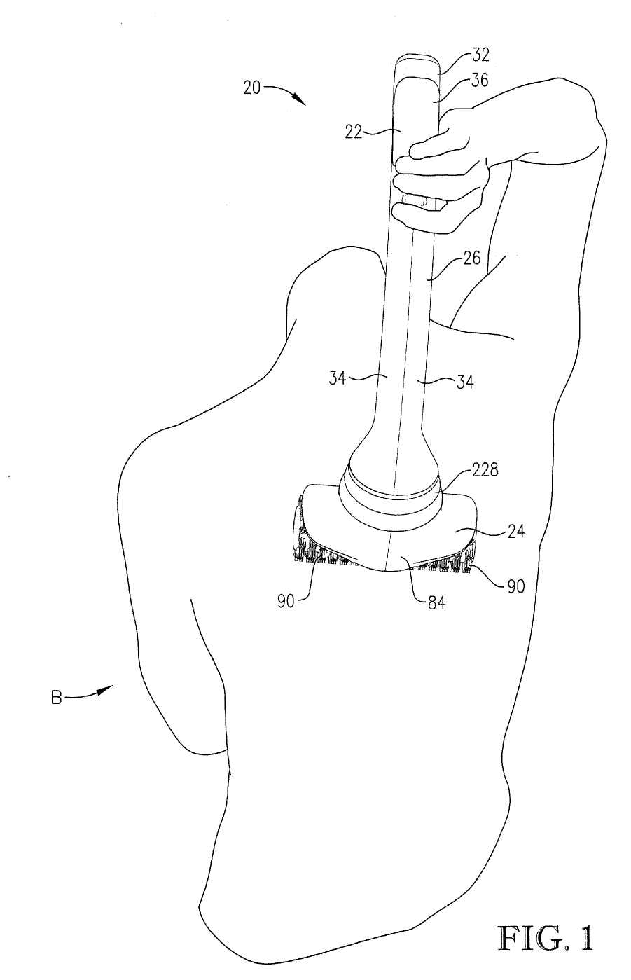

Turning initially to FIG. 1, a powered massaging unit 20 is adaptable for various massaging applications where tissues are manipulated. As will be described in greater detail, the powered massaging unit 20 includes a head that can preferably accept various types of tissue stimulation elements (e.g., rollers and brushes). The illustrated powered massaging unit 20 is also preferably small and compact. The size and configuration of the illustrated unit 20 has been found to be effective for self-massaging (i.e., where an operator uses the unit to manipulate his or her own tissues and thereby massage himself/herself), particularly of hard-to-reach areas such as back B, and also permits the unit to be easily carried by a user. The illustrated massaging unit 20 has also been found to provide various therapeutic benefits through tissue manipulation. As used herein, the term “massage,” “massaging,” etc., refers to various types of tissue manipulation, such as rubbing, kneading, scratching, and tapping. The powered massaging unit 20 broadly includes a control handle 22 and a massage head 24.

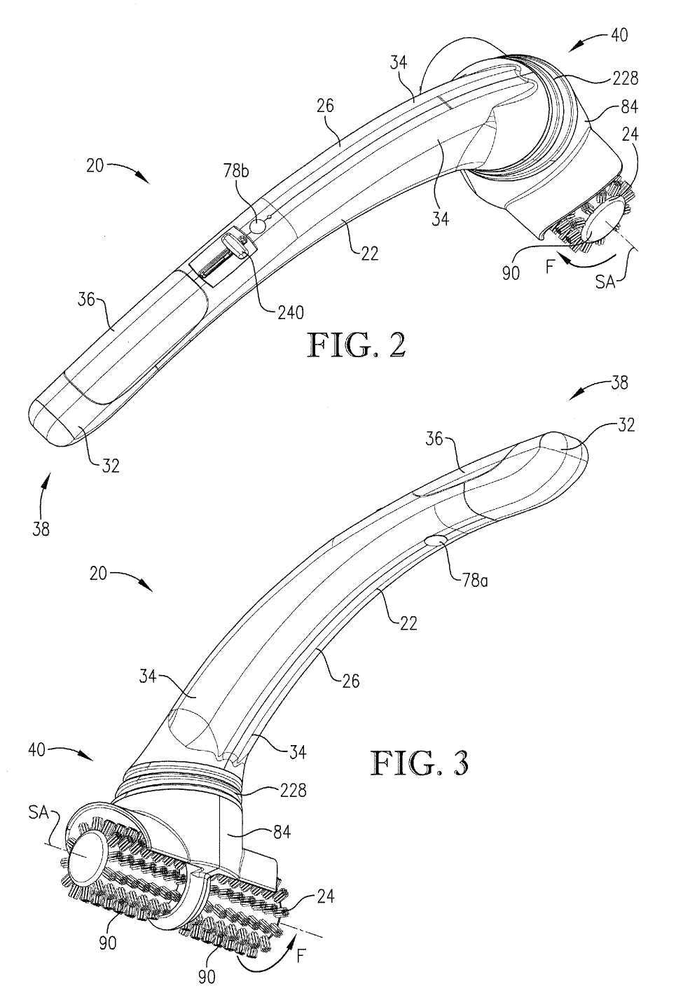

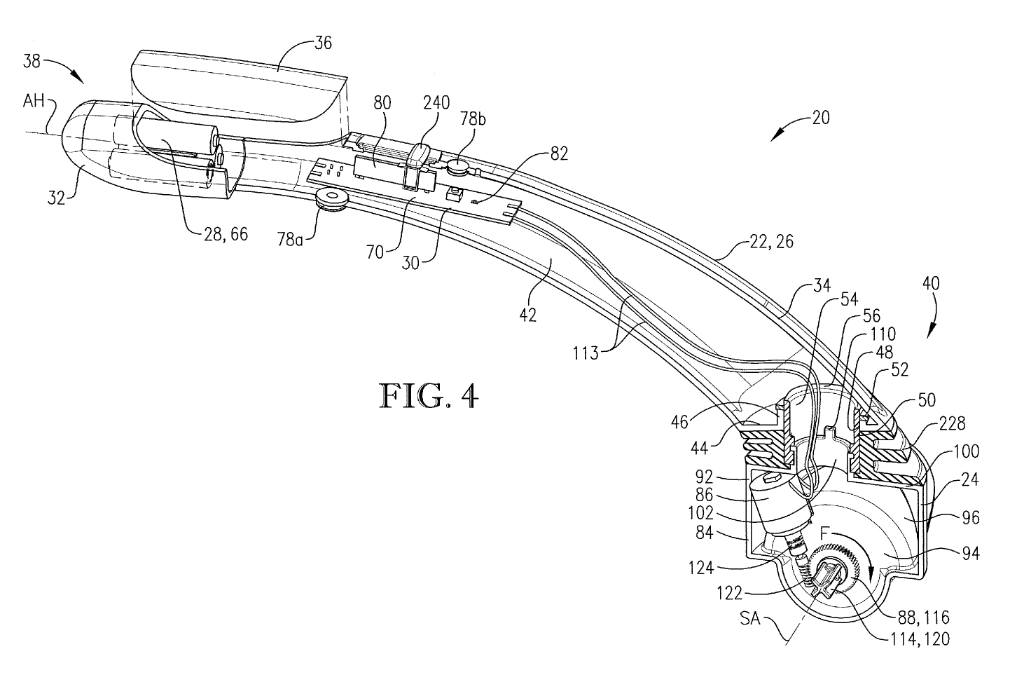

Turning to FIGS. 2-6, the control handle 22 serves to support the massage head 24 in various orientations during use of the powered massaging unit 20. The control handle 22 preferably includes a handle enclosure 26, a power source 28, and a controller assembly 30. The handle enclosure 26 provides a generally rigid housing for the handle 22 and preferably includes proximal handle section 32, distal handle sections 34, and a removable access cover 36. The handle enclosure 26 further presents a proximal gripping end 38 and a distal head-supporting end 40. The enclosure 26 also presents a chamber 42 that receives the power source 28 and controller assembly 30. The sections 32,34 and cover 36 are attached to one another to cooperatively define an elongated, curved handle shape that extends along a curved handle axis AH (see FIG. 4). While the handle enclosure 26 is preferably rigid, the principles of the present invention are applicable where the handle has an adjustable shape. For instance, the handle enclosure 26 could include a pivot joint positioned along the length of handle to allow the handle to be folded onto itself. The handle enclosure 26 could also include multiple telescopic sections so that the handle length can be adjusted. Furthermore, the handle enclosure 26 could include a continuously flexible length. Additional preferred features of these alternative handle constructions are disclosed in the above-incorporated U.S. Provisional Applications.

Adjacent the distal end 40, each distal handle section 40 includes an end wall 44 that presents a generally planar outer wall surface (see FIG. 6). Each distal handle section 40 further includes a curved wall 46 that projects inwardly from the end wall 44, with the walls 46 presenting a bore 48. Preferably, the illustrated handle enclosure 26 further includes a handle sleeve 50 and a snap ring 52 that secures the sleeve 50 within the bore 48. The illustrated sleeve 50 is elongated and presents opposite proximal and distal ends, with a generally round bore 54 extending through the sleeve 50. The proximal end includes an outwardly projecting flange 56. The bore 54 includes an inwardly facing groove 58 adjacent the distal end. The sleeve 50 includes inwardly projecting stops 60 that present stop shoulders 62a,b. As will be discussed, the sleeve 50 preferably provides part of a swivel joint 64 to interconnect the handle 22 and head 24, although the swivel joint 64 could be alternatively configured without departing from the scope of the present invention. Furthermore, the stops 60 preferably serve as restrictions to relative rotational movement between the handle 22 and head 24, as will be discussed in greater detail.

The illustrated sections 32,34 and cover 36 of enclosure 26 are preferably made of synthetic resin material. More preferably, the sections 32,34 and cover 36 include a thermoplastic material, such as ABS. The cover 36 preferably includes a thermoplastic elastomer material, such as Santoprene®. However, the enclosure 26 could include other materials, such as wood or metal, e.g., to provide a suitably strong, resilient, and/or attractive housing, without departing from the scope of the present invention. The illustrated sections 32,34 and cover 36 are preferably injection molded using conventional molding techniques, although other manufacturing processes could be employed to provide desired attributes of the handle enclosure.

The power source 28 includes a plurality of conventional batteries 66 electrically connected to one another and housed within a battery holder (not shown). The batteries 66 are electrically connected to the controller assembly 30 with wires. The principles of the present invention are also applicable where the massaging unit 20 includes an alternative power source configuration. For instance, the power source 28 could have rechargeable batteries, with battery recharging circuitry contained within the handle 22 or a structure external to the massaging unit 20. Furthermore, the massaging unit 20 could receive direct current power from an alternating current source with a conventional power converter that is electrically connected to the massaging unit through a detachable or permanent electrical connection.

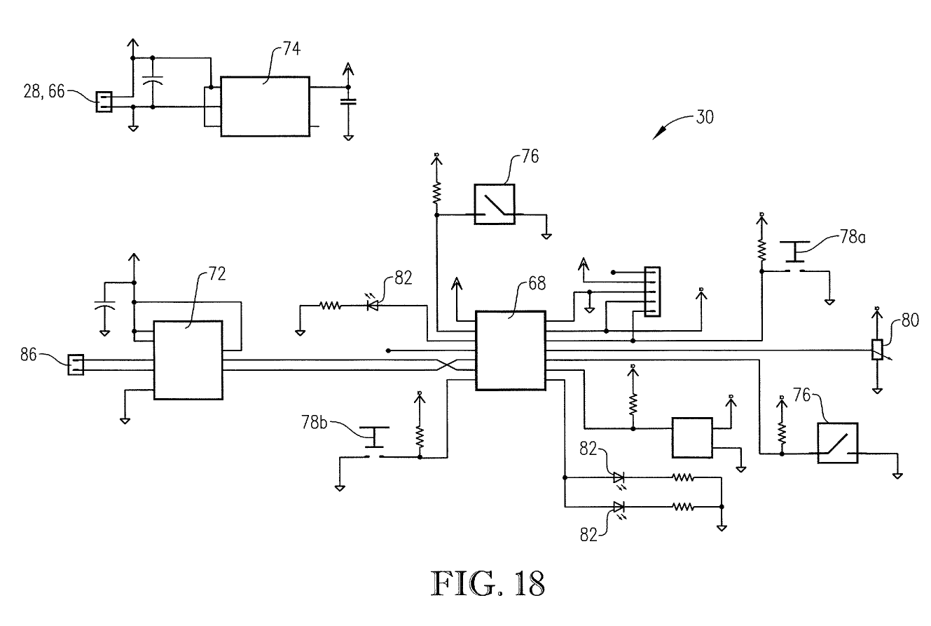

Turning to FIGS. 4 and 18, the controller assembly 30 provides hand-operated control of the massaging unit 20. The controller assembly 30 includes a microcontroller 68 mounted on a circuit board 70. The controller assembly 30 also includes an H-bridge circuit 72 and a voltage regulator circuit 74. The controller assembly 30 further includes tilt sensors 76a,b, switches 78a,b, slide potentiometer 80, and LED lights 82 operably connected to the microcontroller 68, with various resistors and capacitors (see FIG. 18). As will be discussed, the slide potentiometer 80 provides on/off control and variable-speed control of the massaging unit 20. Also, the switch 78a provides forward/reverse control of the massaging unit 20.

The tilt sensors 76 each preferably comprise a switch that senses the orientation of the handle 22 relative to a horizontal direction and provides an on/off signal. The tilt sensors 76 each preferably comprise a ball tilt sensor. However, it is also within the scope of the present invention where other types of motion sensors are used to sense pivotal and/or translational movement of the massaging unit 20. When the sensor 76 is not tilted relative to horizontal (i.e., when the handle 22 is aligned with horizontal, as shown in FIG. 6) or the sensor 76 is tilted at a tilt angle less than a predetermined tilt angle relative to horizontal, the sensor 76 is in a nominal tilt condition and provides a corresponding nominal tilt signal. When the sensor 76 is tilted at a tilt angle greater than the predetermined tilt angle relative to horizontal, the sensor 76 is in an excessive tilt condition and provides a corresponding excessive tilt signal different from the nominal tilt signal. Preferably, the predetermined tilt angle relative to horizontal for tilt sensors 76 ranges from about five (5) degrees to about fifteen (15) degrees and, more preferably, is about ten (10) degrees.

The sensors 76 are mounted in the handle enclosure 26 so that the sensors 76 indicate tilting movement of the handle 22 about the handle axis AH. More specifically, one sensor 76 preferably indicates tilt angle in a counterclockwise direction about the handle axis AH (when looking along the handle axis AH in the distal direction) and the other sensor 76 preferably indicates tilt angle in the clockwise direction about the handle axis AH. However, it is also within the scope of the present invention where a single tilt sensor is employed to sense excessive tilting in both directions. Furthermore, the tilt sensors 76 could be alternatively positioned relative to the massaging unit 20, e.g., where the tilt sensors 76 are incorporated into the head 24.

Turning to FIGS. 4-9, the massage head 24 broadly includes a head enclosure 84, motor 86, transmission 88, and regular rotation massage brushes 90. The head enclosure 84 preferably provides a generally rigid housing for the head 24 and is constructed of two halves. Each enclosure half preferably includes a curved side wall 92, an upright central partition 94, and a laterally extending curved partition 96 that interconnects the side wall 92 and central partition 94. The enclosure halves are preferably attached to each other to cooperatively form a chamber 97 (see FIG. 6). Each head enclosure half also preferably includes a curved guard 98 that is cantilevered from the side wall 92 to extend over a respective brush 90. However, it is within the scope of the present invention where the head enclosure 84 does not include guards 98. The head enclosure 84 also includes a top wall 100 attached to the side wall 92 and presenting a generally planar upper wall surface. It is also within the ambit of the present invention where the head enclosure 84 is alternatively shaped, e.g., to present a more aesthetic shape or to accommodate different sizes and/or types of components.

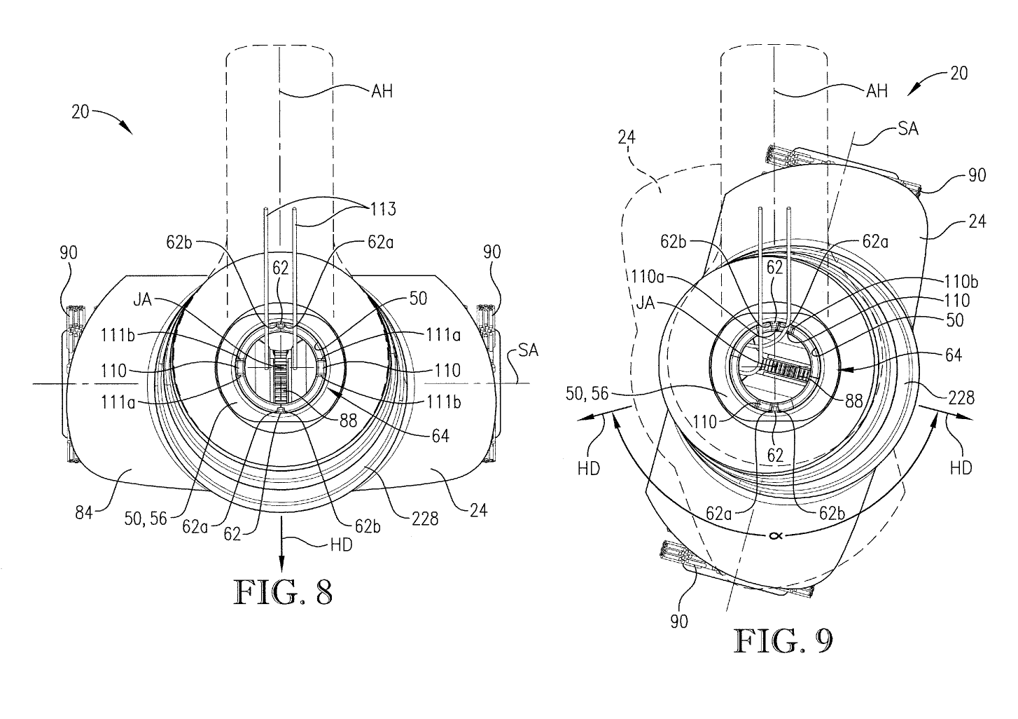

Yet further, the illustrated head enclosure 84 preferably includes a sleeve half 102 attached to the top wall 100. When the enclosure halves are attached to each other, the halves 102 preferably cooperatively form a sleeve 104. The sleeve 104 is elongated and presents opposite proximal and distal ends, with a round bore 106 extending through the sleeve 104 (see FIG. 6). The sleeve 104 includes a proximal annular rim 108 and tabs 110 that project proximally from the rim 108. The tabs 110 present tab shoulders 111a,b (see FIG. 8). The sleeve 104 also presents an outwardly facing annular groove 112 between the proximal and distal ends. As will be discussed, the sleeve 104 preferably provides part of the swivel joint 64 to interconnect the handle 22 and head 24, although the swivel joint 64 could be alternatively configured.

The illustrated head enclosure 84 is preferably made of synthetic resin material. More preferably, the head enclosure 84 includes a thermoplastic material, such as ABS. However, the enclosure 84 could include other materials, such as wood or metal, e.g., to provide a suitably strong, resilient, and/or attractive housing, without departing from the scope of the present invention. The illustrated sections of the head enclosure 84 are preferably injection molded using conventional molding techniques, although other manufacturing processes could be employed to provide desired attributes of the head enclosure 84.

The illustrated motor 86 is preferably a conventional direct current electrical motor. The motor 86 includes a housing, wires 113, and a rotatable output shaft 86a (see FIG. 6). The illustrated motor preferably operates at 4.5 volts and produces a motor shaft rotation speed of about 4000 rpm. However, the motor 86 could operate at an alternative voltage and/or speed without departing from the scope of the present invention.

The transmission 88 serves to transmit power from the motor 86 to the brushes 90 (or other massage elements as will be disclosed). The transmission 88 preferably includes a rotatable drive shaft 114 and a spur gear 116 mounted on the shaft 114 to rotate therewith. The drive shaft 114 includes a shaft element 118 and shaft ends 120 and presents a shaft axis SA substantially orthogonal to the axis of the motor output shaft 86a (see FIGS. 4 and 6) The shaft ends 120 preferably present an X-shaped cross section that is drivingly received by the brushes 90. The drive shaft 114 is inserted through and rotatably supported by the central partitions 94. The transmission 88 further includes a worm 122 that engages the spur gear 116. The illustrated spur gear 116 and worm 122 are preferably made of a nylon material, but could include a metal material or another plastic material. The worm 122 is mounted to the output shaft 86a of the motor 86 with a flexible shaft coupler 124. Thus, rotation of the output shaft 86a causes corresponding rotation of the drive shaft 114, with the worm 122 and spur gear 116 providing a speed reduction from the output shaft to the drive shaft 114. Preferably, the transmission 88 provides a speed reduction ratio that ranges from about 10:1 to about 40:1 and, more preferably, the speed reduction ratio is about 26.7:1. Thus, for a motor shaft rotation speed of 4000 rpm, the illustrated transmission produces a drive shaft rotation speed of about 150 rpm.

The illustrated drive shaft 114 is preferably rotatable and is restricted from sliding along the shaft axis SA. However, for some aspects of the present invention, the drive shaft 114 could be configured to provide alternative driving movement of the brushes 90. For instance, the drive shaft 114 could be constructed to slide the brushes 90 along shaft axis SA, pivot the brushes about an axis other than shaft axis SA, or drive the brushes 90 in a combination of directions, including the massage directions disclosed herein.

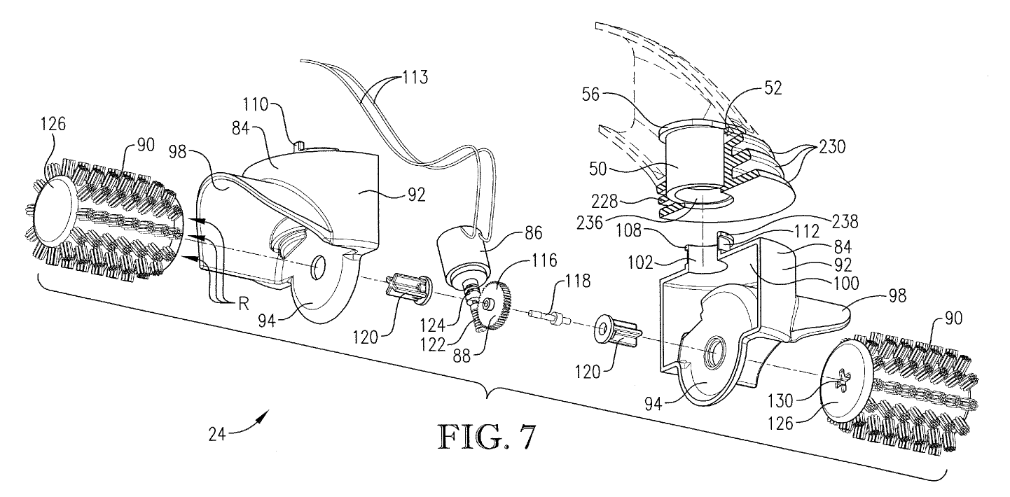

Turning to FIGS. 6 and 7, the brushes 90 are powered by the drive shaft 114 to provide massaging action. Each brush 90 includes a body 126 and multiple bristle groups 128. The body 126 is generally cylindrical and extends between opposite ends thereof. The bristle groups 128 project radially outwardly from the body 126 and each include a plurality of bristles that are tightly grouped to define a group diameter dimension D and a group height dimension H (see FIG. 6). The bristles are preferably made from a synthetic resin material. Preferably, the diameter dimension D and height dimension H both range from about one-quarter to about one-half inch. However, it is also within the scope of the present invention where the bristle groups 128 have alternative configurations. For instance, in an elongated-bristle embodiment (not shown), each bristle group 128 has a diameter dimension D less than one-quarter inch and a height dimension H ranging from about one-half inch to about one inch to provide a relatively low-pressure scratching force. In a single-bristle embodiment (not shown), each bristle group 128 comprises a single bristle, with each bristle including a spherical end section with a diameter of the spherical end section being larger than the diameter of the bristle.

The bristle groups 128 are preferably arranged into longitudinal rows R, with a plurality of rows R being spaced circumferentially about the body 126 (see FIG. 10). Preferably, bristle groups 128 of each row R are longitudinally aligned with corresponding bristle groups 128 of the other rows R. However, it is also within the scope of the present invention where adjacent rows R have bristle groups 128 that are longitudinally offset from one another. For instance, in one offset-bristle embodiment (not shown), the rows R are configured so that every other row R has corresponding bristle groups 128 that are longitudinally aligned with one another. Also, in the elongated bristle embodiment discussed above, the bristle groups are preferably offset in the same manner.

Yet further, it is within the ambit of the present invention where the brush 90 has tissue manipulation elements other than bristles. In a preferred knobbed-surface embodiment (not shown) similar to the offset-bristle embodiment, the offset bristle groups are replaced with generally smooth hemispherical knobs fixed to the body in a plurality of offset rows. In another preferred roller-surface embodiment (not shown) similar to the knobbed-surface embodiment, the spaced apart hemispherical knobs are replaced with knobs having valleys between adjacent knobs and a smooth transition between adjacent knobs and valleys so that a longitudinal cross section of each row of knobs generally produces a continuous sine wave profile. In yet another preferred roller-surface embodiment (not shown) similar to the knobbed-surface embodiment, the hemispherical knobs are replaced with spherical rollers rotatably received in a respective cavity. The rollers are mounted so that about half of each spherical roller protrudes from the body and is free to rotate relative to the body. As will be shown, other preferred rotatable elements can be used as part of the head 24.

Turning again to FIGS. 6 and 7, the body 126 presents a socket 130 at one end of the body 126. The socket 130 removably receives the complementally shaped shaft end 120 of the drive shaft 114 so that the brush 90 can be removably attached to the drive shaft 114. Thus, each brush 90 rotates with the attached drive shaft 114. With both brushes 90 removably attached to the drive shaft 114, the brushes 90 preferably present an overall brush width W that ranges from about four (4) inches to about eight (8) inches and, more preferably, is about six (6) inches. It is also within the ambit of the present invention where the massaging unit 20 spins an alternative number of brushes 90. For instance, the massaging unit 20 could be designed to spin a single brush 90 or multiple brushes 90 attached end-to-end.

When the motor shaft is spun in a forward direction, the illustrated spur gear 116 and brushes 90 normally rotate in the indicated forward direction F (see FIGS. 3 and 4). Thus, when the brushes 90 are in massaging engagement with a user and rotate in direction F, the brushes 90 tend to draw powered massaging unit 20 in a normal head direction HD relative to the head 24. As will be discussed, the motor rotational direction can be reversed by the controller assembly 30.

Turning to FIGS. 10-12, the powered massaging unit 20 also preferably includes a counter-rotation massage brush 132 that can be removably attached to the drive shaft 114 and provides reversed massaging rotation relative to the regular rotation massage brush 90. The massage brush 132 includes a frame 134, an input shaft 136, a transmission 138, a rotatable body 140, and bristle groups 142. The frame 134 includes a tapered outer wall 144 and presents a shaft bore 146. The body 140 includes an outer wall that presents a generally frusto-conical outer surface 148 and an open end 150. The bristle groups 142 are mounted to and project radially outwardly from the body 140 and are spaced uniformly in longitudinal rows, with the rows being spaced circumferentially about the body 140.

The body 140 is rotatably mounted on the frame 134 so as to slidably engage one another. The body 140 is secured for rotational movement about the frame 134 by a retaining ring 152 attached to the open end 150 of the body 140. The ring 152 includes an annular lip 154 that engages a corresponding lip 156 of the frame 134. Thus, the body 140 and bristle groups 142 are rotatable on the frame 134.

The input shaft 136 is elongated and presents a socket 158 at one end thereof and a cylindrical boss 160 at the other end. The boss 160 is rotatably received by the shaft bore 146 so that the input shaft 136 can spin relative to the frame 134.

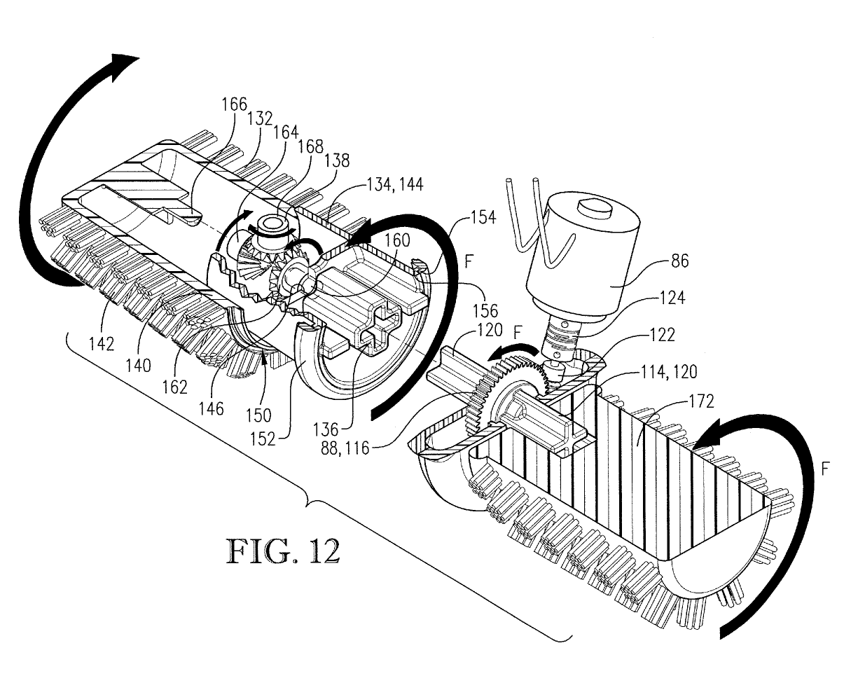

The transmission 138 drivingly interconnects the input shaft 136 and body 140. In particular, the transmission 138 includes three intermeshing bevel gears mounted within the body 140. A drive gear 162 is mounted on the boss 160 and rotates with the input shaft 136. A driven gear 164 is mounted on a boss 166 attached to the body 140 and rotates with the body 140. An intermediate gear 168 is rotatably mounted on a frame boss 170 and can spin relative to the frame 134 (see FIG. 11). The intermediate gear 168 is intermeshed with the other gears 162,164 so that spinning of the input shaft 136 and drive gear 162 in one rotational direction causes spinning of the driven gear 164 and body 140 in the opposite rotational direction (see FIG. 12). The gears 162,164,168 are preferably made of a nylon material, but could include a metal material or another plastic material. While the illustrated transmission 138 is preferred for providing counter-rotation, it is also within the ambit of the present invention where an alternative gear arrangement is used to rotate the body 140 in a direction opposite to the input shaft 136. Furthermore, in another embodiment, the brush 132 could have multiple sections attached end to end and a gear train that drives the brush sections so that adjacent sections rotate in opposite directions.

The massage brush 132 is removably attached to the drive shaft 114 similar to massage brush 90. In particular, the drive shaft end 120 is inserted into the socket 158. In the illustrated embodiment, one of the regular rotation massage brushes 90 is replaced with a tapered regular rotation massage brush 172 and the other brush 90 is replaced with the counter-rotation massage brush 132 so that the brushes 132,172 spin in opposite directions when powered (see FIGS. 11 and 12). Alternatively, one of the massage brushes 90 could be used with the counter-rotation massage brush 132. Thus, when the spur gear 116 and brush 172 rotate in the forward direction F, the transmission 138 drives the body 140 in a reverse direction opposite the forward direction F.

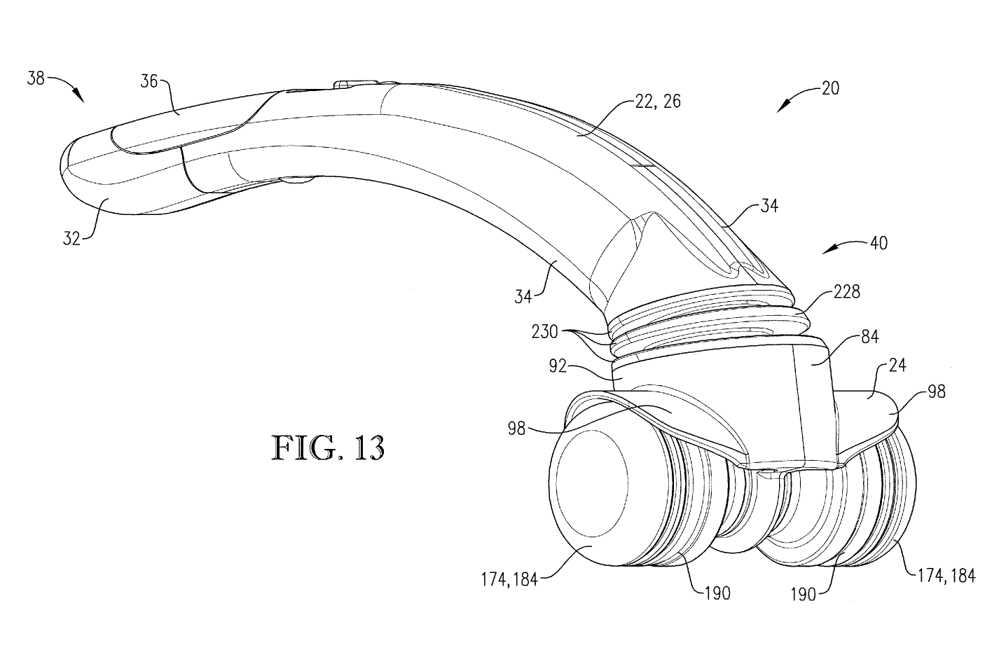

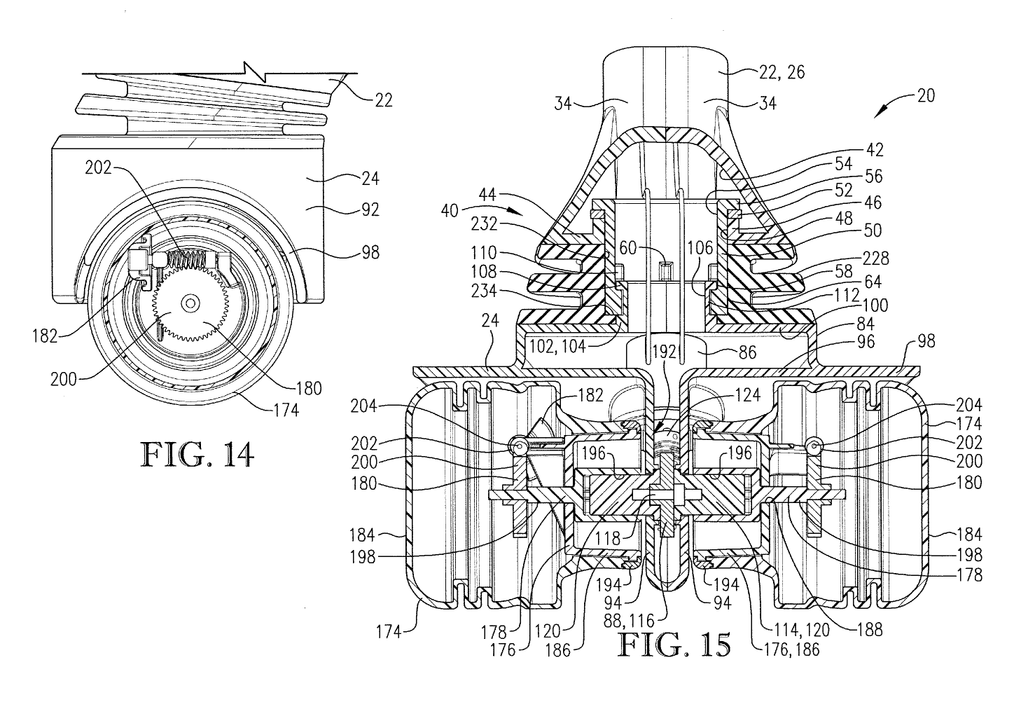

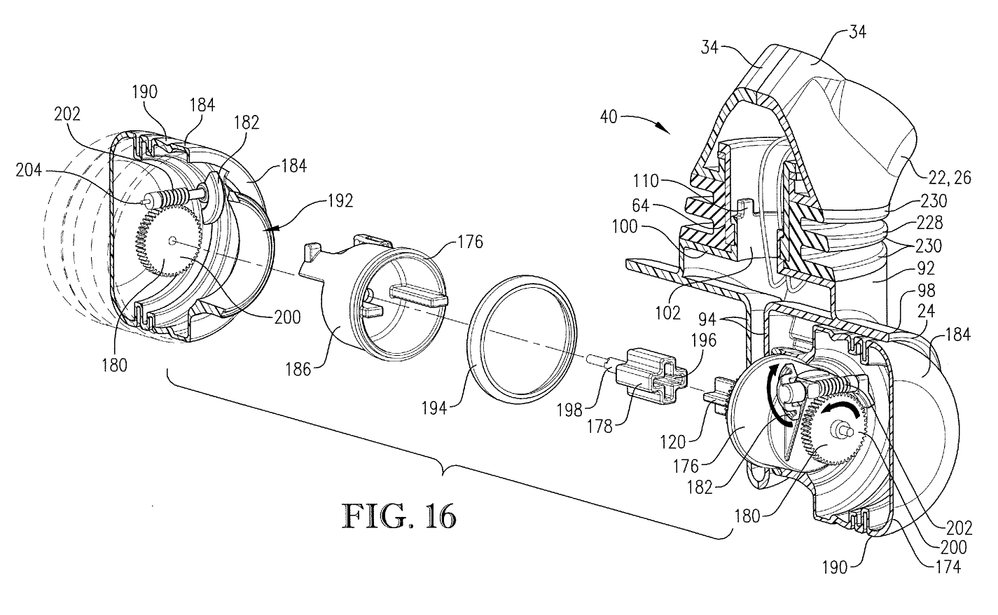

Turning to FIGS. 13-16, the powered massaging unit 20 further preferably includes a pair of vibration rollers 174 that can be removably attached to the drive shaft 114 and cause the head 24 of the massaging unit 20 to vibrate. Each vibration roller 174 includes a frame 176, an input shaft 178, a transmission 180, a vibration mass 182, and a rotatable body 184 (see FIG. 16). The frame 176 includes a tapered outer wall 186 and presents a shaft bore 188 (see FIG. 15). The roller body 184 includes a contoured outer wall that presents an annular contoured massage surface 190 and an open end 192 (see FIG. 16). The massage surface 190 includes multiple endless grooves spaced longitudinally from one another. The massage surface 190 could be variously configured to provide desired tissue manipulation.

The body 184 is rotatably mounted on the frame 176 so as to slidably engage one another. The body 184 is secured for rotational movement about the frame 176 by a retaining ring 194 attached to the open end 192. The ring 194 includes an annular lip that engages a corresponding lip of the frame 176. Thus, the body 184 is rotatable on the frame 176.

The input shaft 178 is elongated and presents a socket 196 at one end thereof and cylindrical boss 198 at the other end. The boss 198 is rotatably received by the shaft bore 188 so that the input shaft 178 can spin relative to the frame 176.

The transmission 180 drivingly interconnects the input shaft 178 and vibration mass 182. In particular, the transmission 180 includes a spur gear 200 and a worm 202. The spur gear 200 is mounted on the boss 198 and rotates with the input shaft 178. The worm 202 is mounted on a worm shaft 204 that is rotatably supported by the frame 176. The vibration mass 182 is mounted on one end of the worm shaft 204, with the vibration mass 182 having a center of mass offset from the axis of the worm shaft 204. The worm 202 and spur gear 200 are intermeshed so that spinning of the drive shaft 114 and spur gear 200 causes spinning of the worm 202, worm shaft 204, and vibration mass 182. The worm 202 and spur gear 200 are preferably made of a nylon material, but could include a metal material or another plastic material.

The vibration roller 174 is preferably removably attached to the drive shaft 114 similar to massage brushes 90,132,172. In particular, the drive shaft end 120 is inserted into the socket 196. In the illustrated embodiment, the regular rotation massage brushes 90 are replaced with the vibration rollers 174 so that the rollers 174 cause vibration of the head 24 when the rollers 174 are powered. For some aspects of the present invention, the vibration roller 174 could be fixed to the drive shaft 114. Also, the illustrated vibration roller 174 is preferably mounted to the head in an exposed condition. However, the head 24 could be configured so that the vibration mechanism of roller 174 is mounted within the chamber 97.

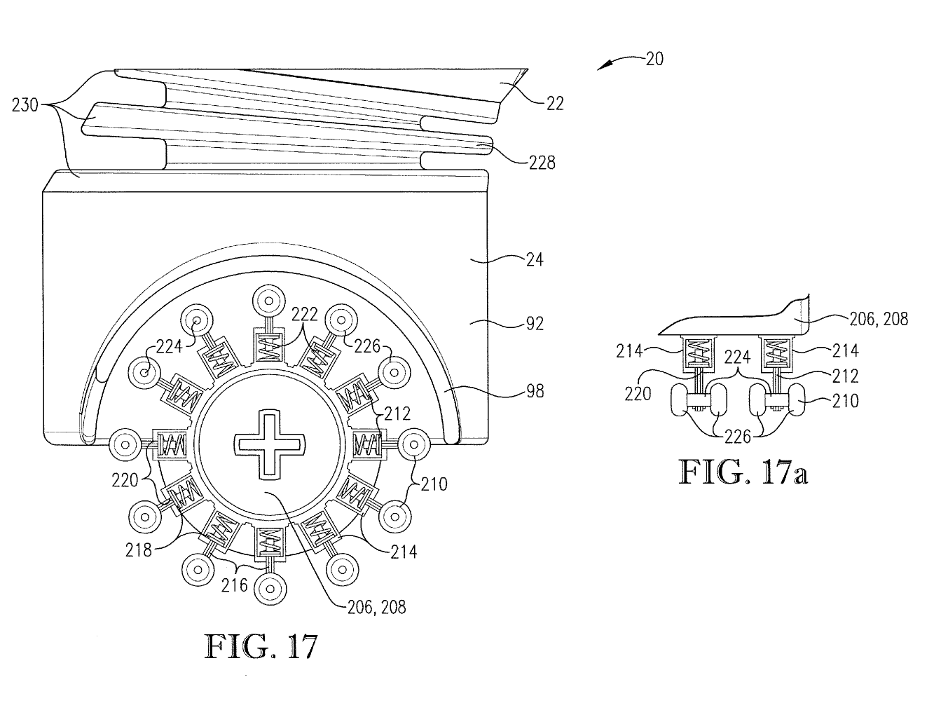

Turning to FIGS. 17 and 17a, the powered massaging unit 20 further preferably includes a pair of spring-loaded roller assemblies 206 that can be removably attached to the drive shaft 114. Each roller assembly 206 includes a body 208, rollers 210, and pistons 212 that support the rollers 210. The body 208 includes a cylindrical base and a plurality of cylinders 214, with the cylinders 214 arranged in longitudinal rows of multiple cylinders 214, and with the rows being spaced circumferentially about the base.

The pistons 212 include a shaft 216 with an X-shaped cross section and a washer 218 fixed to the shaft 216. Each cylinder 214 includes an endwall that presents an opening 220. The opening 220 is complementally shaped to and slidably receives a corresponding piston 212. Thus, the piston 212 is slidable into and out of the cylinder 214 but does not rotate within the cylinder 214. The assembly 206 further includes springs 222 that engage a corresponding washer 218 and resiliently urge the piston 212 into a radially outermost position.

The rollers 210 include a roller shaft 224 and a pair of wheels 226 rotatably mounted to the shaft 224. The shaft 224 is mounted transverse to shaft 216 so that the axis of shaft 224 is parallel to the axis of roller assembly 206. Furthermore, the wheels 226 are all preferably positioned at substantially the same radial distance from the axis of the roller assembly 206 when the pistons 212 are urged into their radially outermost positions. In this manner, the illustrated roller assembly 206 is configured to engage and roll over uneven tissue surfaces while maintaining similar pressures among a plurality of wheels 226 engaged with the tissue surface.

It is also within the ambit of the present invention where combinations of roller and/or brush features are incorporated into a rotatable massage element for the head 24. For instance, the brushes 90,132 and/or roller assemblies 206 could also include a vibration mechanism.

The illustrated massaging unit 20 preferably includes multiple massaging elements (i.e., brushes 90,132,172, rollers 174, and roller assemblies 206). Nevertheless, the principles of the present invention are equally applicable where massaging unit 20 includes an alternative set of massaging elements that can be interchangeably attached and used as part of the massaging unit 20.

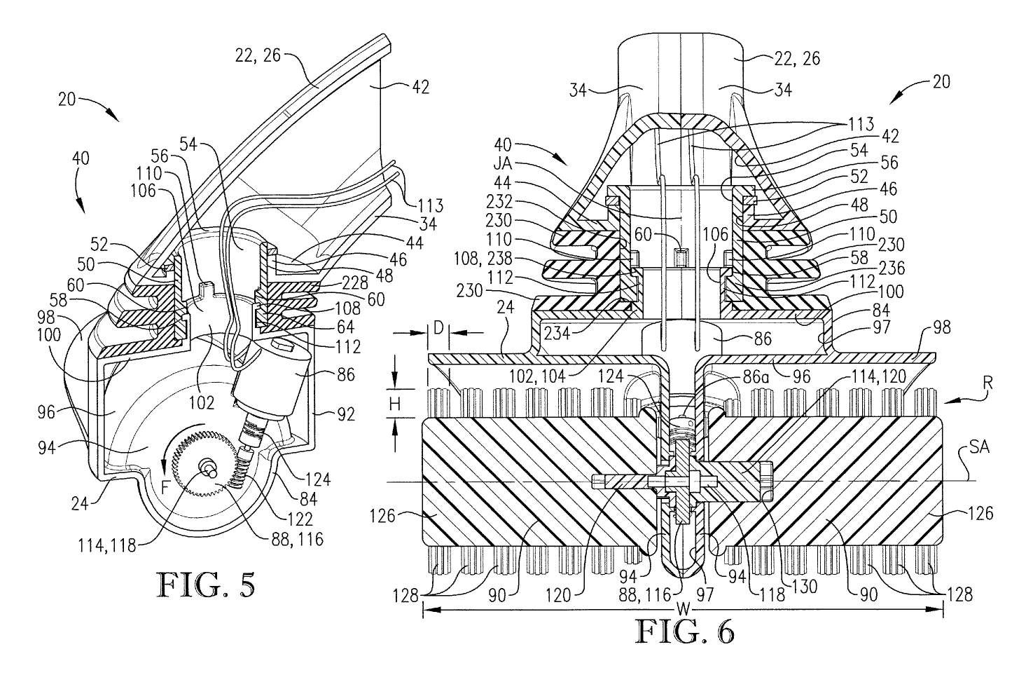

Turning to FIGS. 5-7, the powered massing unit 20 also includes an isolating spacer 228 that restricts vibration produced by the head 24 from traveling to the handle 22. The illustrated spacer 228 is preferably unitary and includes multiple annular ribs 230 spaced axially apart from each other along the length of the spacer 228. The spacer 228 also presents an axial bore 232 that extends through the spacer 228, with a shoulder 234 positioned adjacent one end of the bore 232 (see FIG. 6). The spacer 228 further presents top and bottom planar end surfaces. The spacer 228 is mounted on the sleeve 50 by sliding the distal end of sleeve 50 into the proximal end of the spacer 228. Thus, the spacer 228 generally encircles the swivel joint 64. The spacer 228 is slid onto the sleeve 50 so that the proximal end surface of spacer 228 engages the planar surface presented by the handle enclosure 26. Furthermore, the distal end of the sleeve 50 engages the shoulder 234.

Turning to FIGS. 6-9, the illustrated handle 22 and head 24 are preferably shiftably connected to one another by sleeves 50,104 so that the sleeves 50,104 cooperatively provide the swivel joint 64. With the spacer 228 received on sleeve 50, the head enclosure 84 is shifted to insert the sleeve 104 into the distal end of the sleeve 50. The sleeves 50,104 are slid into engagement with one another so that an annular lip 236 of sleeve 50 snaps into and becomes rotatably received by groove 112 of sleeve 104. Furthermore, an annular lip 238 of sleeve 104 snaps into and is rotatably received by groove 58 of sleeve 50. In this manner, the sleeves 50,104 are rotatably engaged with one another for relative rotation about a joint axis JA (see FIGS. 6 and 8). With the head 24 in the position shown in FIGS. 2 and 3, the massage unit preferably presents a maximum length dimension that ranges from about twelve (12) inches to about twenty-four (24) inches and, more preferably, is about eighteen (18) inches.

With the sleeves 50,104 in swiveling engagement, the bores 54,106 cooperatively present an opening of the swivel joint 64. The swivel joint opening preferably remains open as the head 24 swivels relative to the handle 22. In this manner, wires 113 can extend from the motor 86 and through the opening so that the wires 113 can be attached to the controller assembly 30. Furthermore, the swivel joint opening permits the wires 113 to maintain electrical interconnection between the controller assembly 30 and motor 86 as the handle 22 and head 24 swivel relative to one another so that power transmission from the controller assembly 30 to the motor 86 is not interrupted by swivel movement. For some aspects of the present invention, the swivel joint 64 could be alternatively configured to permit power transmission between the handle 22 and head 24.

The illustrated sleeves 50,104 provide a preferred pair of connectors to pivotally interconnect the handle 22 and head 24 while permitting power transmission between the handle 22 and head 24. However, for some aspects of the present invention, an alternative connector construction could be used so that the swivel joint 64 permits relative pivotal movement between the handle 22 and head 24. For instance, the swivel joint 64 could include a ball-and-socket assembly that presents the swivel joint opening. For some aspects of the present invention, the swivel joint 64 could be formed by a flexible tube including a plurality of tube segments connected end to end, with adjacent segments pivotally connected to one another.

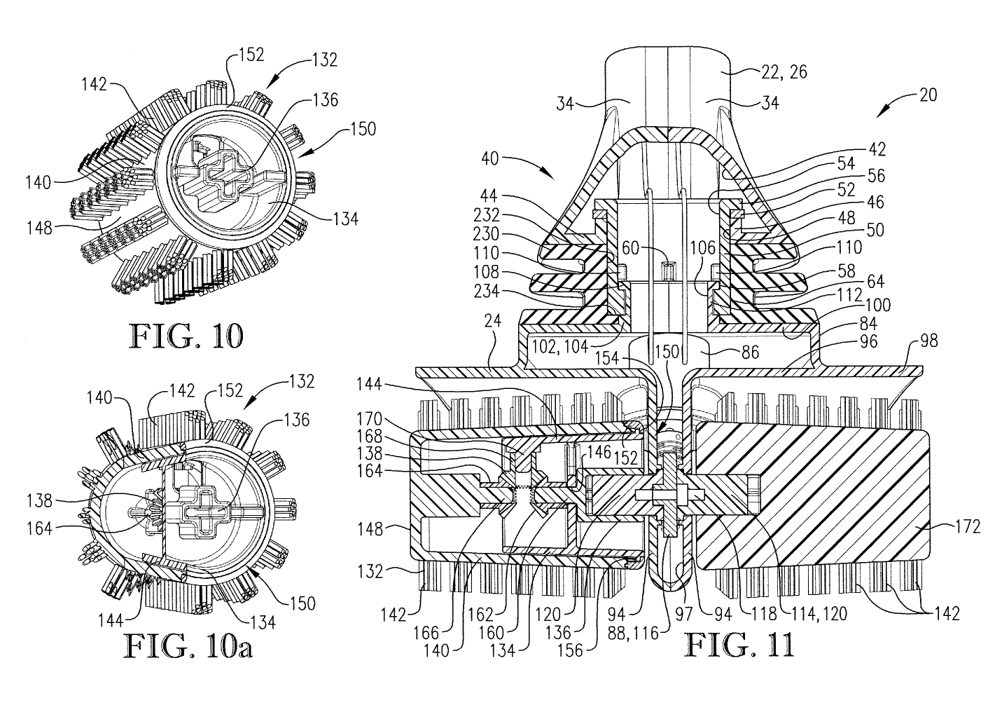

Turning to FIGS. 8 and 9, the stops 60 and tabs 110 cooperatively permit limited relative rotational movement between the head 24 and handle 22. In particular, the stops 60 and tabs 110 cooperatively define a range of continuous swivel movement between the predetermined positions. The stops 60 each present pairs of stop shoulders 62a,b and the tabs 110 present pairs of tab shoulders 111a,b.

The head sleeve 104 is rotatable relative to the handle sleeve 50 into and out of one predetermined rotational position where corresponding stop shoulders 62a and tab shoulders 111a engage one another (see FIGS. 8 and 9). In this rotational position, the head 24 is rotated to a corresponding maximum counterclockwise extent relative to the handle 22 and assumes a corresponding position where the normal head direction HD is pointed left of the handle axis AH. Also in this position, the shaft axis SA extends along the handle axis AH.

The head sleeve 104 is also rotatable relative to the handle sleeve 50 into and out of another predetermined rotational position where corresponding stop shoulders 62b and tab shoulders 111b engage one another (see FIG. 9). In this rotational position, the head 24 is rotated to a corresponding maximum clockwise extent relative to the handle 22 and assumes a corresponding position where the normal head direction HD is pointed right of the handle axis AH. Again, the shaft axis SA extends along the handle axis AH in this position.

Again, the stops 60 and tabs 110 cooperatively define an angle α between the predetermined positions through which continuous swivel movement between the handle 22 and head 24 is preferably permitted (see FIG. 9). For instance, the sleeves 50,104 are rotatable into a third predetermined rotational position spaced between maximum clockwise and counterclockwise positions where the normal head direction HD is pointed in a forward massage direction, with the shaft axis SA being substantially orthogonal to the handle axis AH (see FIG. 8). Preferably, the angle α of head movement ranges from about one hundred thirty-five (135) degrees to about one hundred eighty (180) degrees.

For some aspects of the present invention, the illustrated swivel joint 64 could be alternatively configured to provide adjustable interconnection between the head 24 and handle 22. For instance, the sleeves 50,104 could be alternatively configured to provide corresponding pairs of shoulders to limit relative rotational movement. Furthermore, the swivel joint 64 could include detent elements so that the sleeves 50,104 can be resiliently and removably retained in predetermined positions.

Turning to FIGS. 2-4, the controller assembly 30 provides hand-operated control of the massaging unit 20. The slide potentiometer 80 provides on/off control and variable-speed control of the massaging unit 20. In particular, the potentiometer 80 preferably includes a slider 240 that is shiftable between an “off” position and a maximum speed position (see FIG. 4). As the slider 240 is moved progressively toward the maximum speed position, power transmitted to the head 24 increases progressively. Also, when the slider 240 is moved out of the “off” position, a corresponding one of the LED lights 82 is illuminated to provide visual indicia to the user that corresponds to the massaging unit 20 being turned on. The brightness of the one LED light 82 is preferably constant when the slider 240 is positioned among the range of “on” positions. However, the brightness of the one LED light 82 could be increased or decreased with a corresponding increase or decrease in power transmission to the head 24.

The switch 78a provides forward/reverse control of the massaging unit 20. Shifting the switch 78a between first and second conditions causes the microcontroller 68 to reverse the rotational direction of the motor shaft. In particular, shifting between the conditions causes the microcontroller 68 to flip the voltage polarity to the motor 86 so as to reverse motor shaft rotation.

The tilt sensors 76 cooperative with the microcontroller 68 to provide tilt control of the massaging unit 20. Again, the sensors 76 are preferably mounted in the handle enclosure 26 so that the sensors 76 indicate tilting movement of the handle 22 about the handle axis AH. However, the tilt sensors 76 could be alternatively positioned relative to the massaging unit 20, e.g., where the tilt sensors 76 are incorporated into the head 24.

Shifting the switch 78b between first and second conditions causes the microcontroller 68 to activate or deactivate a programmed tilt function. A corresponding LED light 82 is illuminated to provide visual indicia to the user that corresponds to activation of the tilt function. When the tilt function is not activated, the rotational direction of the motor 86 and brushes 90 can only be manually selected by the user. When the tilt function is activated, the microcontroller 68 receives tilt signals received from the tilt sensors 76 and can select the rotational direction of the motor shaft and brushes 90. In particular, the microcontroller 68 will change the brush rotational direction if the brushes 90 are rotating in the wrong direction. Even when the tilt function is activated, if both tilt sensors 76 are in the nominal tilt condition, the rotational direction of the motor 86 and brushes 90 is preferably only selected by the user. That is, the microcontroller 68 will not change the rotational direction of the motor 86 and brushes 90 when the tilt sensors 76 send nominal tilt signals to the microcontroller 68.

Preferably, the head 24 is shifted to the left-most head condition when the tilt function is activated so that the shaft axis SA extends along the handle axis AH (see FIG. 9), although the tilt function could be utilized with other head orientations (e.g., where the head is in the right-most head condition). In this left-most head condition, when the handle 22 is tilted counterclockwise beyond the predetermined counterclockwise tilt angle (when viewing the massaging unit 20 along the handle axis AH in the distal direction), the corresponding tilt sensor 76 will be in the excessive tilt condition and will send an excessive tilt signal to the microcontroller 68. The microcontroller 68 is programmed so as to shift the brushes 90 into or maintain the brushes 90 in a counterclockwise rotational condition (as determined when viewing the brushes 90 in a distal direction along the handle axis AH) in response to the corresponding excessive tilt signal. Thus, while counterclockwise tilting of the handle 22 causes the handle 22 to move laterally relative to the head 24, the microcontroller 68 can cause the brushes 90 to rotate in response to excessive handle tilting about the shaft axis SA so that the head 24 generally follows the counterclockwise tilted handle 22.

Similarly, when the handle 22 is tilted clockwise beyond the predetermined clockwise tilt angle, the microcontroller 68 will shift the brushes 90 into or maintain the brushes 90 in a clockwise rotational condition (when viewing the massaging unit 20 along the handle axis AH in the distal direction) in response to the corresponding excessive tilt signal. Thus, while clockwise tilting of the handle 22 causes the handle 22 to move laterally relative the head 24, the microcontroller 68 can cause the brushes 90 rotate in response to excessive handle tilting about the shaft axis SA so that the head 24 generally follows the clockwise tilted handle 22.

The tilt sensors 76 and microcontroller 68 could be alternatively configured to provide automated rotational control of the brushes 90. For instance, the tilt sensors 76 could be incorporated into the head 24 so that the sensors 76 generally sense nominal or excessive tilting of both the head 24 and handle 22. In this manner, the sensors 76 and microcontroller 68 could drive the brushes 90 in response to tilting about the shaft axis SA when the head 24 is in any pivotal position relative to the handle 22.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby state their intent to rely on the Doctrine of Equivalents to determine and assess the reasonably fair scope of the present invention as pertains to any apparatus not materially departing from but outside the literal scope of the invention as set forth in the following claims.

What is claimed is:

1. A powered massaging assembly operable to manipulate tissue, said powered massaging assembly comprising:
a control handle including a handle enclosure; and
a massage head including a head enclosure that presents a chamber, a shiftable drive shaft that extends into and out of the chamber, and a driven massage element drivingly attached to the drive shaft, with the driven massage element being mounted outside the chamber to engage and thereby manipulate tissue,
said enclosures each including a respective connector, with the connectors being rotatably attached to one another to cooperatively provide a swivel joint that interconnects the enclosures,
said connectors cooperatively presenting an opening through the swivel joint so that the swivel joint permits power transfer from a location within the handle enclosure to the chamber by passing through the opening and thereby powering the drive shaft.

2. The powered massaging assembly as claimed in claim 1,
said connectors each comprising a sleeve, with one sleeve rotatably received by the other sleeve,
said sleeves presenting respective shoulders, with the shoulders being engageable to cooperatively locate the head in a predetermined position, and with the shoulders restricting relative rotation of the sleeves out of the predetermined position in a rotational direction.

3. The powered massaging assembly as claimed in claim 2,
one of said sleeves presenting an annular groove and the other of said sleeves including an annular lip slidably received in the annular groove, with the sleeves being interconnected so that relative axial movement between the sleeves is restricted while relative rotational movement between the sleeves is permitted.

4. The powered massaging assembly as claimed in claim 2,
said sleeves presenting another pair of shoulders that cooperatively locate the head in another predetermined position when the another pair of shoulders are engaged with each other,
said shoulders restricting relative rotation of the sleeves out of the another predetermined position in another rotational direction opposite the first-mentioned rotational direction,
said pairs of shoulders cooperatively defining an angle of swivel movement between the predetermined positions.

5. The powered massaging assembly as claimed in claim 4,
said drive shaft presenting a drive axis and said handle defining a handle axis,
one of said predetermined positions associated with the drive and handle axes extending substantially orthogonal to one another,
the other of said predetermined positions associated with the drive and handle axes extending generally along the same direction.

6. The powered massaging assembly as claimed in claim 4,
said swivel joint defining a swivel axis and said handle defining a handle axis,
said axes being transverse to one another.

7. The powered massaging assembly as claimed in claim 1; and
an isolating spacer positioned between the enclosures, with the spacer operating to restrict vibration produced by the massage head from traveling to the handle.

8. The powered massaging assembly as claimed in claim 7,
said spacer being mounted on at least one of the sleeves and generally encircling the swivel joint.

9. The powered massaging assembly as claimed in claim 1,
said swivel joint defining a swivel axis and said handle defining a handle axis,
said axes being transverse to one another.

10. The powered massaging assembly as claimed in claim 1,
said massage head including a motor mounted in the chamber, with the motor including electrical wires that supply power to the motor,
said motor being electrically connected relative to the power source by the wires so that the wires transmit power between the power source and motor, with the wires extending through the swivel joint.

11. The powered massaging assembly as claimed in claim 10,
said drive shaft comprising a rotatable drive shaft,
said massage head including a transmission that includes the rotatable drive shaft,
said motor including an output shaft substantially orthogonal to the rotatable drive shaft,
said transmission including a drive gear powered by the motor and a driven gear attached to the rotatable drive shaft, with the gears in driving engagement with one another so that rotation of the output shaft causes rotation of the drive shaft.

12. The powered massaging assembly as claimed in claim 1,
said control handle including a control assembly operably coupled to the motor,
said control assembly including a tilt sensor that senses handle orientation relative to horizontal,
said tilt sensor including a predetermined tilt angle relative to horizontal, with the tilt sensor having nominal and excessive tilt conditions in opposite tilt directions from the predetermined tilt angle,
said tilt sensor being mounted within the handle enclosure so that the conditions are associated with corresponding tilt positions of the handle, with the control assembly operable to effect a change in motor shaft rotation when the tilt sensor is shifted from the nominal tilt condition to the excessive tilt condition.

13. The powered massaging assembly as claimed in claim 1,
said massage head including another driven massage element, with the driven massage elements being interchangeably attachable to the drive shaft so that the attached massage element is driven by the drive shaft.

14. The powered massaging assembly as claimed in claim 1,
said massage head including another drive shaft that extends into and out of chamber and another driven massage element rotatably mounted outside the chamber and driven by the another drive shaft.

15. The powered massaging assembly as claimed in claim 1,
said driven massage element including a frame and a massage body operable to manipulate tissues,
said body being rotatably mounted on the frame so as to rotate relative to the frame.

16. The powered massaging assembly as claimed in claim 15,
said drive shaft comprising a rotatable drive shaft,
said driven massage element including an input shaft and a transmission supported by the frame, with the input shaft being drivingly attached to the rotatable drive shaft,
said transmission interconnecting the input shaft and body, with the input shaft being rotatable in one rotational direction by the drive shaft and the body being powered by the transmission so as to rotate in the opposite rotational direction.

17. The powered massaging assembly as claimed in claim 1,
said driven massage element including a frame and a rotatable mass rotatably supported by the frame,
said driven massage element including an input shaft and a transmission that interconnects the input shaft and rotatable mass, with the rotatable mass being driven by rotation of the input shaft.

18. The powered massaging assembly as claimed in claim 17,
said driven massage element including a rolling element rotatably mounted on the frame so as to rotate relative to the frame.

19. The powered massaging assembly as claimed in claim 1,
said driven massage element including a body and a spring-loaded roller assembly,
said roller assembly including a roller and a resilient mechanism that supports the roller relative to the body,
said resilient mechanism urging the roller into a radially outermost position relative to the body and resiliently permitting shifting of the roller toward the body.

20. A method of controlling a massaging device with a rotating massage element, said method comprising the steps of:
(a) providing a shifting signal by sensing shifting of the device handle relative to the device massage element in a massage direction, with sensing being performed by a movement sensor of the massaging device; and
(b) changing the rotational direction of the massage element in response to the shifting signal with a controller that receives the shifting signal and correspondingly controls power to the device massage element.

21. The method as claimed in claim 20,
step (b) including the step of changing massage element rotation to a rotational direction that encourages device movement in the massage direction.

22. The method as claimed in claim 21;
(c) providing a second shifting signal by sensing the shifting of the device handle relative to the device massage element in a second massage direction, with sensing being performed by another movement sensor of the massaging device; and
(d) changing rotation of the device massage element to a second rotational direction generally opposite to the first-mentioned rotational direction in response to the second shifting signal with the controller receiving the second shifting signal and correspondingly controlling power to the device massage element to change the rotation.

23. The method as claimed in claim 20; and
(c) swiveling the device massage element relative to the device handle from a first position to a second position,
step (c) being performed prior to step (a).
